(19) United States
(12) Patent Application Publication
(10) Pub. No.: US 2026/0093738 A1
(43) Pub. Date: Apr. 2, 2026

(54) LARGE LANGUAGE MODEL-BASED COMMUNICATION ASSISTANT

(71) Applicant: Apple Inc., Cupertino, CA (US)

(72) Inventors: Lorenzo BERTIZZOLO, San Francisco, CA (US); Murali Mohan CHAKKA, Los Gatos, CA (US); Prashant H. VASHI, San Jose, CA (US)

(21) Appl. No.: 18/904,009

(22) Filed: Oct. 1, 2024

(51) Int. Cl. G06F 16/33; G06F 40/20

(52) U.S. Cl. CPC G06F 16/3344; G06F 40/20

(57) ABSTRACT

Systems and methods provide for training a machine learning model for handling communications on behalf of the user are provided. A plurality of contextual information and a plurality of prior communications is selected based on one or more pre-configured data privacy settings. A training dataset is generated using the contextual information and the prior communications. A machine learning model is trained that can receive a query from an entity and in response, generate a response for the entity. The response is then transmitted back to the entity.

### TECHNICAL FIELD

This disclosure relates to virtual assistants, and more specifically to systems and methods for training a machine learning model for handling communications on behalf of the user.

### BACKGROUND

Virtual assistants (or digital assistants or intelligent automated assistants) on user devices such as smartphones, tablets, personal computers etc., are software applications that can engage in conversations with their users and can perform functions, including for example searching for content, checking-in to a flight, setting a calendar appointment, and so on. These virtual assistants are capable of natural language processing (NLP) that allows them to understand human language as it is spoken and written.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system providing a training platform for training machine learning models according to aspects of the subject technology.

FIG. 3 illustrates an example of user interface for configuring data privacy settings according to aspects of the subject technology.

FIG. 4 illustrates an example of user interface for configuring entity specific data privacy settings according to aspects of the subject technology.

FIG. 5 illustrates an example continuous training of machine learning models.

FIG. 6 illustrates an example use of a large language model-based communication assistant in conjunction with a wearable device.

FIG. 7 illustrates a flowchart of an example process that may be performed by an electronic device to train a machine learning model according to aspects of the subject technology.

FIG. 8 illustrates an example execution of application programming interface (API) instructions according to aspects of the subject technology.

FIG. 9 illustrates an example execution of application programming interface (API) instructions according to aspects of the subject technology.

FIG. 10 illustrates an example computing architecture of a device according to aspects of the subject technology.

FIG. 11 illustrates an example computing architecture of a system according to aspects of the subject technology.

FIG. 12 illustrates an example execution sequence of API instructions according to aspects of the subject technology.

FIG. 13 illustrates an example execution sequence of API instructions according to aspects of the subject technology.

FIG. 14 illustrates an example electronic system with which aspects of the subject technology may be implemented in accordance with one or more implementations.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

Virtual assistants may assist users with various tasks that can be controlled based on interactions between a user and the virtual assistant, such as retrieving information and/or performing basic actions/automations. However, virtual assistant technology, e.g., trained using large language models, may also be capable of interacting with third parties on behalf of the user. For example, a virtual assistant can be expanded to handle communications such as incoming/outgoing calls and texts on behalf of the user. To effectively communicate on behalf of the user, the virtual assistant can include a machine learning model (e.g., a large language model) that is trained using the user’s prior communications (e.g., voice calls, voicemails, text messages, etc.) to learn the user’s communication style and/or preferences. However, given that the virtual assistant communicates with third parties on a user’s behalf, the user may wish to have discrete and/or granular control over which of their prior communications are used to train the large language model used by the virtual assistant.

The subject technology allows for users to discretely configure and/or control the prior communication data that is used to train large language model(s) used by a virtual assistant, for example, on a per entity basis. An entity can be an individual (or an electronic device such a smartphone of the individual) with whom the user had prior communications. Entities can include individuals who are related to the user as friends, family, colleagues, customer care support, etc. Entities can also include interactive voice response (IVR) systems, and/or other virtual assistants, with which the user and/or the user’s device had prior communications.

The discrete training of the large language models on a per entity basis allows the virtual assistant to learn the language, syntax, vocabulary, and/or choice of words that are frequently used by the user of the user device, e.g., when communicating with each respective entity. When the virtual assistant is subsequently communicating with an entity on behalf of the user, the virtual assistant can receive queries from the entity and can use the LLM to generate responses to the queries that are in the communication style used by the user for the entity.

To train the LLM, a general training dataset may first be generated using prior communications of the user with other entities along with contextual information associated with the user. The contextual information can include information collected from a profile of the user, and/or collected from native and/or third-party applications executing on the user’s device. Subsequently, a respective secondary training dataset is generated for each respective entity that includes a set of words used in prior communications with the respective entity. The LLM is then finetuned using each respective secondary training dataset.

In generating both the general training dataset and the respective secondary training datasets, the subject system allows the user to configure data privacy settings for each entity thereby allowing the user to control which communication data is used in training each of the respective LLMs. In this manner, the subject system provides for discrete and granular control of the user’s prior communication data that is used to train the respective LLM for each entity which may conserve processing, memory, and/or communication resources by allowing for more efficient communications between the virtual assistant and each respective entity.

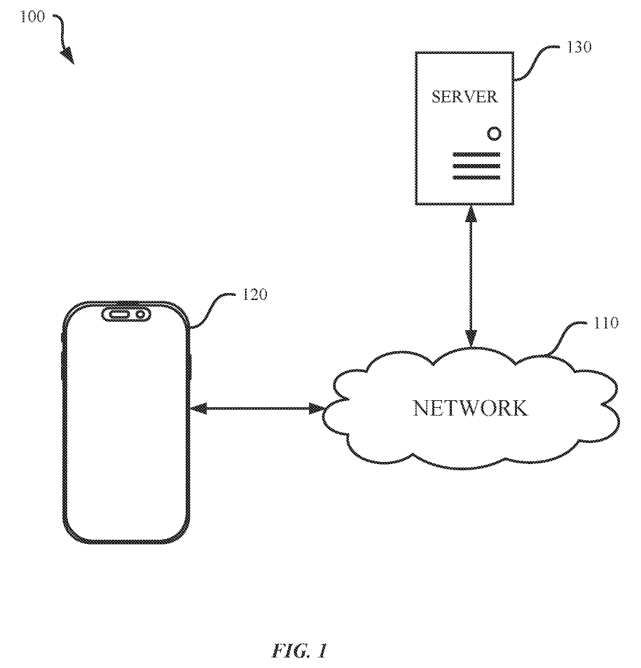

FIG. 1 illustrates an example network environment 100 according to aspects of the subject technology. Not all the depicted components may be used in all implementations, however, and some implementations may include additional or different components than those shown in the figure. Variations in the arrangement and type of the components may be made without departing from the scope of the claims as set forth herein. Additional components, different components, or fewer components may be provided.

The network environment 100 includes a user device 120 and a server 130 connected via a network 110. The network 110 may communicatively (directly or indirectly) couple server 130 and the user device 120. The network 110 is not limited to any particular type of network, network topology, or network media. The network 110 may be a local area network (LAN) or a wide area network (WAN). The network 110 may be an interconnected network of devices that may include or may be communicatively coupled to the Internet. For explanatory purposes, the network environment 100 is illustrated in FIG. 1 as including the user device 120 and the server 130. However, the network environment 100 may include any number of user devices and any number of servers and/or other computing/networking devices.

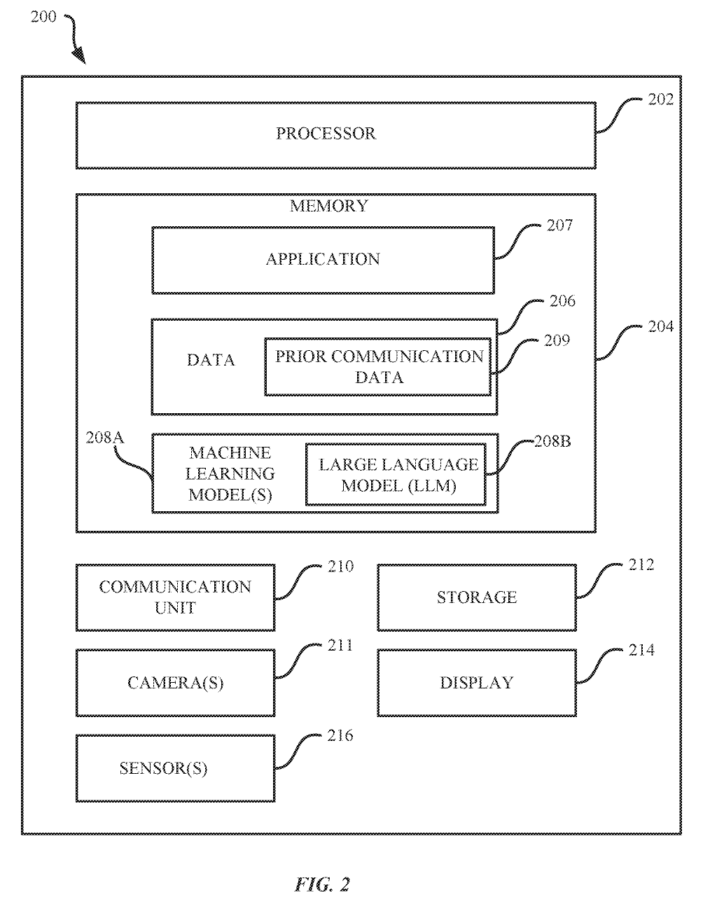

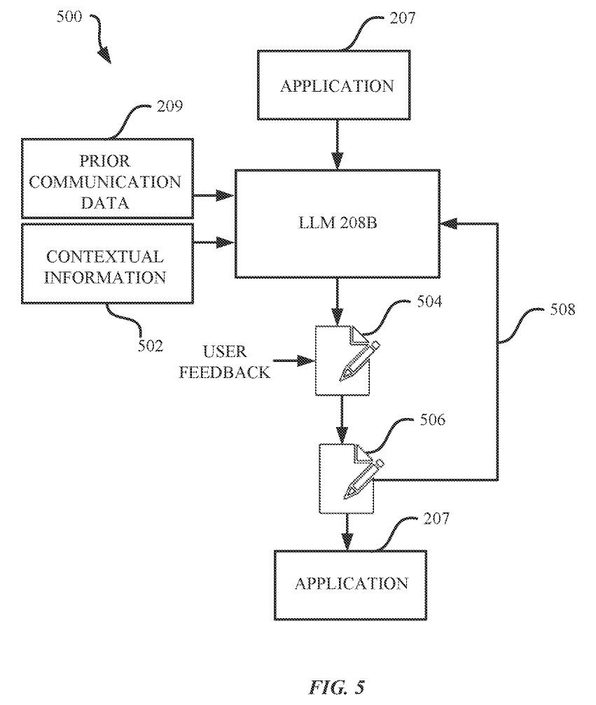

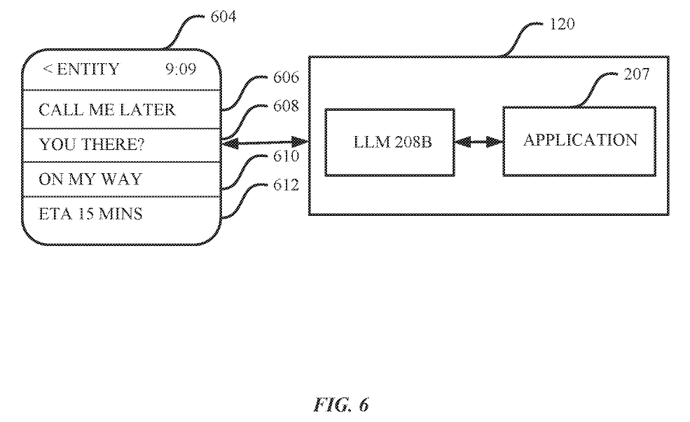

The user device 120 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the user device 120 is depicted as a smartphone. The user device 120 may be, and/or may include all or part of, the system discussed below with respect to FIG. 2 and/or with respect to FIG. 6.

In some implementations, the user device 120 may provide a system for training a machine learning model using training data, where the trained machine learning model is subsequently deployed locally at the user device 120. Further, the user device 120 may provide one or more frameworks for training machine learning models and/or developing applications using the machine learning models. In an example, the user device 120 may be an electronic device (e.g., a smartphone, a tablet device, a laptop computer, a desktop computer, a wearable electronic device, etc.) that can be used to communicate with entities like friends, family, colleagues, customer care support, interactive voice response (IVR) systems, etc.

In one or more implementations, one or more frameworks for training machine learning models may be provided by one or more other user devices that are associated with the same user account as the user device 120. For example, the one or more other user devices may have more processing, memory, and/or power resources for training machine learning models. The one or more other user devices may then securely deploy the trained machine learning models directly on the user device 120, e.g., without facilitation from a server. In this manner, the machine learning models can be trained using the user’s prior communication data without providing the user’s prior communication data to a server.

In some implementations, the server 130 may provide a platform to securely train one or more machine learning models for secure deployment to a client electronic device (e.g., the user device 120). The machine learning model deployed on the user device 120 may then perform one or more machine learning tasks. In some implementations, the server 130 may provide a cloud service that securely utilizes the trained machine learning model and is continually refined over time. The server 130 may be, and/or may include all or part of, the system discussed below with respect to FIG. 2 and/or with respect to FIG. 6.

FIG. 2 illustrates an example system 200 in accordance with some implementations of the subject technology. In an example, the system 200 may be implemented in the user device 120 or the server 130. In another example, the system 200 may be implemented either in a single device or in a distributed manner in a plurality of devices, the implementation of which would be apparent to a person skilled in the art.

In an example, the system 200 may include a processor 202, memory 204 (memory device) and a communication unit 210. The memory 204 may store data 206 and one or more machine learning models 208A. In an example, the system 200 may include or may be communicatively coupled with a storage 212. Thus, the storage 212 may be either an internal storage or an external storage. In the example of FIG. 2, the system 200 includes one or more camera(s) 211, a display 214, and one or more sensors(s) 216. Sensor(s) 216 may include location sensors (e.g., satellite positioning system sensors), motion sensors (e.g., inertial sensors), and/or depth sensors (e.g., stereo cameras, LIDAR sensors, radar sensors, time-of-flight sensors, or the like).

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 204 may include one or more applications 207 that can be executed, and/or are currently being executed, on the system 200, such as a messaging application or generally any application. The one or more applications 207 can interact with each other or with an operating system of the system 200 using application programming interfaces (API) to send or receive data. The one or more applications 207 can also include respective user interfaces (UI) to facilitate user-interaction, enabling the user to provide inputs and receive output seamlessly. For example, when implemented in the user device 120, the system 200 can execute the messaging application that can provide a UI to receive inputs from the user of the user device 120.

The data 206 may represent, amongst other things, a repository of data processed, received, and generated by one or more processors such as the processor 202. Data may include prior communication data 209 that includes all prior communications of the user with other entities. The prior communication data 209 can include the prior text messages and transcribed phone conversations. The prior communication data 209 can also be stored in the storage 212 if not used actively in training machine learning model(s). However, while training machine learning model(s), the processor 202 can retrieve the prior communications data 209 from the storage 212. One or more of the aforementioned components of the system 200 may send or receive data, for example, using one or more input/output ports and one or more communication units.

The machine learning model(s) 208A, in an example, may include one or more of machine learning based models and artificial intelligence-based models, such as, for example, LLM 208B, or any other models and/or machine learning architectures. In an example, the machine learning model(s) 208A may be trained using training data (e.g., included in the data 206 or other data) and may be implemented by the processor 202 for performing one or more of the operations, as described herein.

In an example, the communication unit 210 may include one or more hardware units that support wired or wireless communication between the processor 202 and processors of other computing devices.

The user can use the user device 120 to communicate with one or more entities. These entities may include individuals, such as friends, family, colleagues, professionals (e.g., doctors, dentists, etc.), customer care representative, etc. In some implementations, these entities can also include interactive voice response (IVR) systems of organizations such as banks, Department of Motor Vehicles (DMV), etc. In one or more implementations, the communications can be carried out using short messaging service (SMS) provided by cellular network provider(s), or via native messaging applications of the user device 120. The communication can also be carried out via third party applications on the user device 120. These communications can include text messages and recordings of telephonic conversations between the user and the one or more of entities. In some implementations, each telephonic conversations can be transcribed to generate a corresponding text. For example, the memory 204 of the user device 120 can include a speech to text synthesizer that can process telephonic conversations to generate corresponding text thereby transcribing the conversation. In some implementations, the communications between the user and the one or more of entities can be stored in the storage 212 of the user device 120, such as in the form of the data 206.

To train the LLM 208B, the processor 202 can select one or more prior communications of the user with one or more entities to generate a training dataset. In some implementations, the processor 202 performs the selection based on one or more configurable data privacy settings. The user can configure the one or more data privacy settings to prevent sensitive information such as user’s address, location, phone number, financial information, etc., from being delivered to entities who according to the user should not have access to such sensitive information. For example, the user may want to share the user’s address with an entity such as a friend. However, the user may not want to share the user’s address with an entity such as a customer care representative. Similarly, the user may communicate with their friends’ using words or phrases that they may not use when communicating with work colleagues. The configurable data privacy settings and the manner in which they are configured are described below.

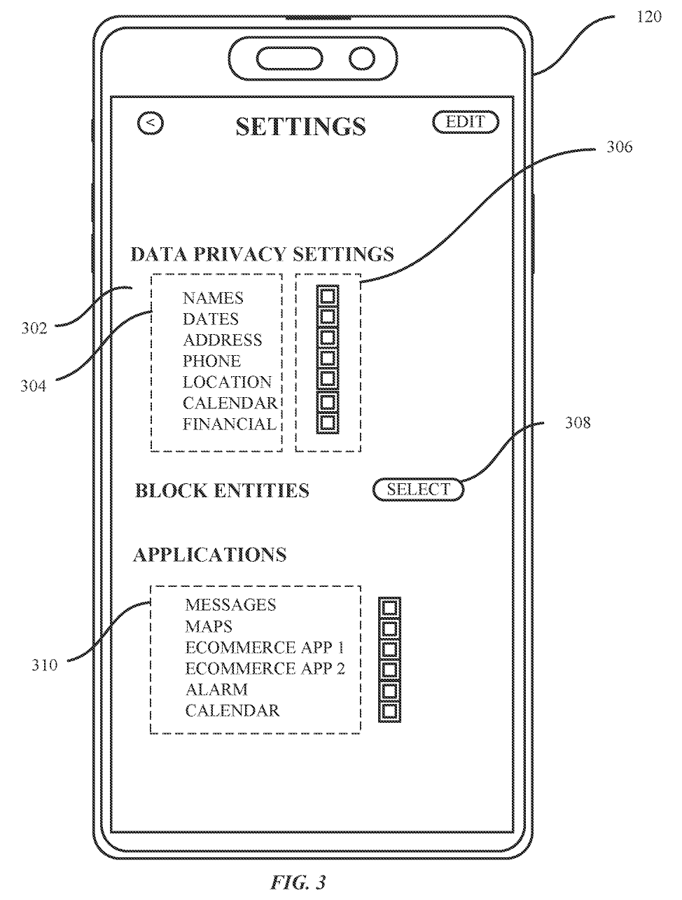

In some implementations, the one or more configurable data privacy settings prevent sensitive information from being included in the training dataset. For example, assume that during a particular communication with an entity such as a friend, the user of the user device 120 shares the user’s address with the entity. If the particular communication is included in the training dataset, the LLM 208B can learn the address of the user during training. This can raise a privacy issue since the LLM 208B can generate a response that includes the user’s address for an entity who should not have access to this information. To prevent the LLM 208B from learning sensitive information the user can specify datatypes that can be excluded from the training dataset. This is further explained with reference to FIG. 3.

FIG. 3 shows an example user interface (UI) of an application executing on the user device 120 for configuring the one or more data privacy settings 302. In this example, the user can select one or more datatypes 304 such as names, dates, addresses, phone numbers, location, calendar, and financial information. If the user selects a particular datatype 304 using the check boxes 306, then any prior communication between the user and the one or more of entities that includes information related to the particular datatype is selected for the training dataset. For example, the processor 202 can use a data labelling model to label each communication with the corresponding datatypes. As for another example, the prior communication between the user and the one or more of entities can be pre-labelled or classified as including one or more datatypes. For example, after every communication between the user and an entity, the processor 202 can prompt the use to label the communication using one or more datatype labels. If the user provides the labels, the processor 202 will consider the communication for inclusion in the training dataset it the communication meets the one or more privacy settings.

The processor 202 can then use the labels to select communications for the training dataset based on one or more datatypes specified by the user. For example, if a communication includes an address, the communication will be labelled by the processor 202 (e.g., using the data labeling model) by assigning the label “Address.” If the user selects the datatype address, the processor 202 will check if the communication was labelled as “Address.” Since the communication was labelled as “Address,” the processor 202 will not select the communication for the training dataset. In some implementations, the user can block communications with one or more selected entities from being included in the training dataset. For example, the user of interact with the select option 308 to select one or more entities. In such implementations, the processor 202 will check whether the user blocked the entity. If the entity was blocked, the processor 202 will skip all prior communications between the user and the blocked entity.

In some implementations, the processor 202 can select a one or more of contextual information associated with a user for training the LLM 208B. Contextual information associated with the user can include the contextual information from one or more user accounts of the user. For example, the user can have multiple user profiles on the user device 120. For example, the user can have a user profile to play online games using the user device 120. As for another example, the user can have another user profile for accessing social media on the user device 120. These user profiles can include contextual information such as user interest, likes and dislikes. In some implementations, these user profiles are stored in the storage 212 of the user device 120. In such implementations, the processor can retrieve contextual information associated with the user from the storage 212.

In some implementations, contextual information associated with the user can also include information from one or more native or third-party applications. In general, native, or third-party applications executing on the user device 120 can store their respective data 206 in the storage 212. In such implementations, the processor 202 can retrieve contextual information from the storage 212 based on one or more data privacy settings. For example, the user may want the LLM 208B to be able to respond to a meeting request scheduled by an entity (e.g., a colleague) for a particular date and time. In such implementations, the user may want the LLM 208B to learn the relationship between the user’s prior communications and past calendar schedules obtained from the calendar application. If the LLM 208B is trained on the user’s past calendar schedule, the LLM 208B will learn the user’s preferred days and/or times for the meeting (such as based on when the user scheduled similar meetings in the past) and generate a response for the meeting request. For example, the LLM 208B can accept the meeting request on behalf of the user if the user is available for the meeting during the scheduled date and time. The LLM 208B can also reject the meeting request if the user is unavailable. As for another example, if the user is unavailable, the LLM 208B can generate one or more timeslots based on the user’s availability as a response to the meeting request. The timeslots can be transmitted back to the entity as a response to the meeting request.

In some implementations, the user can configure data privacy setting for selecting contextual information associated with a user. In the example provided in FIG. 3, the user can select one or more types of contextual information 310 for inclusion in the training dataset. For example, if the user selects the datatype alarm, the processor 202 can retrieve past schedules of the user’s alarm from the storage 212 and include the past alarm schedules in the training dataset. As for another example, the user’s contextual information can also include different user profiles and user behavioral patterns (e.g., likes, dislikes, etc.) For example, the user can have a user profile for social networking, online gaming, ecommerce, etc. The user can select one or more of these user profiles for inclusion in the training dataset. For example, if the user selects the user’s ecommerce profile for inclusion in the training dataset, the processor 202 can retrieve data related to the user’s past purchases using the user device 120 or any ecommerce applications from on the storage 212. The processor can also retrieve any reviews provided by the user in the past along with the user’s selection criteria while purchasing the one or more products.

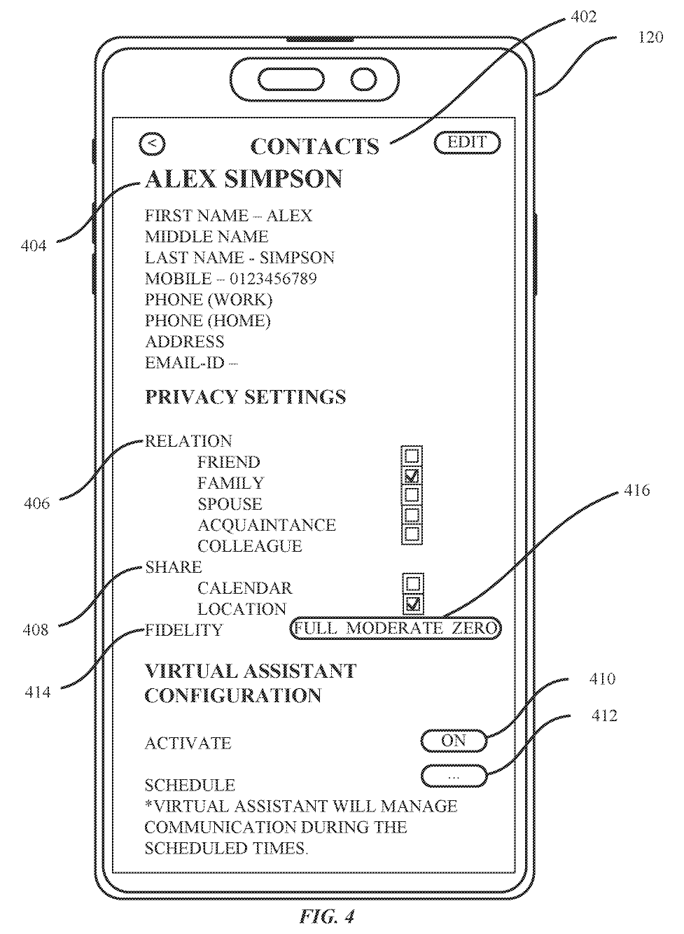

In some implementations, the user may want the LLM 208B to generate responses based on the relationship the user has with other entities. For example, if a first entity is a friend and a second entity is an acquaintance, the LLM 208B responses for the first entity should be friendlier than the LLM 208B responses for the second entity. In other words, the responses generated for the second entity should be in a neutral and a formal language. However, the responses for the first entity should be in a friendlier language. As for another example, the user may be willing to share the user’s location with entities such as family members, spouse, or friends but not with entities such as acquaintances. As for another example, the user may want to share the user’s location with certain member of the family or friends. These one or more configurable data privacy settings are a subset of the data privacy settings and a specific to each of the one or more of entities. In other words, the user can configure the subset of data privacy settings for each of the one or more of entities. This is further explained with reference to FIG. 4.

FIG. 4 shows an example UI for configuring the entity specific data privacy settings. The user device 120 can include an application (referred to as contacts application 402) that manages information such as phone numbers, electronic mail identifier (email-id), address etc., of the one or more of entities. As described before, these entities are individuals who may be, for example, friends, family, colleagues, customer care support, interactive voice response (IVR) systems, etc. The user can select an entity in the contacts application and configure data privacy settings for that entity. With reference to FIG. 4, user selects an entity named “Alex Simpson (404)” which causes the contacts application to display information such as the name, phone number and address of the entity “Alex Simpson”. As shown in FIG. 4, the user can specify the relationship 406 between the user and the entity along with information 408 which the user is willing to share with the entity “Alex Simpson.” In this example, the processor 202 can select communications between the user and the entity “Alex Simpson” that includes location information for inclusion in the training dataset.

In some implementations, the user of the user device 120 can specify whether the user is willing to use the virtual assistant to manage communications with the entities. For example, the user can toggle the option 410 to specify that the user is willing to use the virtual assistant to manage communications with the entity “Alex Simpson.” In some implementations, the user can further specify the date, time, and duration during which the user is willing to use the virtual assistant for managing calls with the entity “Alex Simpson.” For example, the user can schedule the use of the virtual assistant using the scheduler option 412.

In some implementations, the user can specify a fidelity level 414 for the entities. The fidelity level 414 can indicate the degree of user resemblance in the response generated by the LLM 208B. For example, if the user opts for full fidelity using a selectable control option 416 for the entity “Alex Simpson”, the LLM 208B can generate responses that fully resembles the user. For example, the LLM 208B can generate textual responses that are similar to prior responses provided by the user in terms of vocabulary, grammar, and tone of the language. As for another example, the LLM 208B can generate an audio response using the synthesizer that would mimic the user’s voice, vocabulary, and speech patterns (e.g., such as based on prior user audio calls, prior user voice interactions with the virtual assistant, and/or a user voice registration process). As for another example, if the user opts for low level fidelity using selectable control option 416 for the entity “Alex Simpson”, the LLM 208B can generate formal responses. For example, the LLM 208B can generate textual responses in a neutral and formal language irrespective of the vocabulary, grammar, and tone of the language of the prior responses provided by the user. As for another example, if the user opts for moderate level fidelity, the LLM 208B can generate responses using the vocabulary, grammar, and tone of the language previously used by the user. However, the generated response would not include sensitive information.

In some implementations, the fidelity level can signify whether the responses generated by the LLM 208B can include sensitive information (e.g., personal and/or private information such as name, address, phone number, driver’s license number, social security number (SSN), financial information, etc.) For example, if the user opts for low level fidelity for the entity “Alex Simpson,” the LLM 208B can generate responses without including any sensitive information.

In some implementations, the processor 202 can generate a training dataset based on the selected prior communications and contextual information. For example, the processor 202 can retrieve stored prior communications between the user and the one or more of entities from the storage 212 of the user device 120. The processor 202 can also retrieve contextual information of the one or more native and/or third-party applications from the storage 212 of the user device 120. As for another example, the processor 202 can retrieve contextual information related to the user’s from on the storage 212. The contextual information can include user behavioral data from one or more user profiles and one or more native or third-party applications. The processor can also retrieve any reviews provided by the user in the past along with the user’s selection criteria while purchasing the one or more products.

Note that the selection of prior communications and contextual information may be based on the previously discussed one or more data privacy settings that may be configured by the user of the user device 120.

Despite of the one or more pre-configured data privacy settings, the processor may still be able to select prior communications and contextual information that include sensitive information (or private/confidential information). Sensitive information of the user can include the user’s name, address, phone number, social security number (SSN), vehicle number, information regarding payments and credit cards, etc. Such a scenario may occur when the user uses informal languages in prior communications. For example, labeling communications using data labelling models (e.g., as previously discussed) may become erroneous when the communications include informal language such as slangs, abbreviations, signs, etc. If the prior communications are labelled incorrectly, the processor may accidentally select one or more communications that include sensitive information.

To circumvent the issue, the processor 202 can process the selected prior communications and contextual information to evaluate whether the selected prior communications and contextual information includes any sensitive information. The selected prior communications and contextual information can be processed using techniques such as rule based model that relies on predefined rules to detect sensitive information. Other techniques for identifying sensitive information can include using machine learning models that are trained to identify sensitive information.

In some implementations, in response to detecting sensitive information, the portions containing such information can be removed. For example, assume that one of the prior communications includes the user’s bank account number. In response to detecting the user’s bank account number, the processor 202 can remove the bank account number from the prior communication. As for another example, the processor 202 can replace the bank account number with dummy values (e.g., all zeros). As for another example, the processor 202 can skip the communication from being included in the training dataset. If the processor 202 determines that a particular prior communication does not include any sensitive information, the processor 202 can include the particular prior communication as a training sample in the training dataset.

Besides checking for sensitive information, the processor 202 can also perform sentiment analysis of each of the selected prior communications. For example, the processor 202 can use rule based and/or machine learning techniques (e.g., NLP, feature extraction, linear regression, naive bayes, support vector machines) to determine the sentiments of each of the selected prior communications. If the sentiments determined for any of the selected prior communications belong to a predetermined list of sentiments (e.g., anger, frustration, or resentment), the communication can be skipped from being included in the training dataset.

In some implementations, sentiment analysis can also include determining the tone of the communications. For example, the processor 202 can classify each of the selected prior communications as positive, negative, or neutral. In such scenarios, the system 200 can skip communications with a negative polarity from being included in the training dataset. If the processor 202 (e.g., using rule based and/or machine learning techniques) determines that the sentiment of a particular prior communication is permitted by the user (i.e., the sentiment is not listed in the predetermined list of sentiments), the processor 202 can include the particular prior communication as a training sample in the training dataset.

In some implementations, each training sample of the training dataset includes a query and a response based on prior communications between the user and the one or more of entities. For example, assume that a communication between the user and a particular entity include a query from the entity and a response from the user. For example, assume that the query is a text message that says “Hi. Did you go to the supermarket to get the dryer?” Further assume that the user responded to this query by a response that says “Sorry. I was busy over the weekend. I will go later this week.” The corresponding training sample for this communication will include the query and the response as a pair. In some implementations, the training samples of the training dataset can further include one or more additional attributes. In some implementations, these one or more additional attributes can include the one or more data privacy settings pre-configured by the user of the user device 120. In some implementations, the one or more additional attributes can further include contextual information retrieved from one or more native and/or third-party applications.

In some implementations, training the LLM 208B can include a multi-stage learning process. The multi-stage training of the LLM 208B can include pre-training the LLM 208B followed by finetuning the LLM 208B for specific tasks. The multi-stage training of the LLM 208B can further include finetuning the LLM 208B for each entity using the entity specific dataset. The multi-stage training of the LLM 208B is described below.

In some implementations, the user device 120 can provide a platform for pre-training the LLM 208B. In this step, the user device 120 can train the LLM 208B on vast amounts of unlabeled textual data such as books, articles, and websites. During the training process, the one or more of training parameters of the LLM 208B are adjusted to capture the underlying patterns, structures, and semantic knowledge of the unlabeled textual data. In some implementations, the server 130 can also provide a secure privacy-enabled platform (e.g., using a secure processing enclave of the server 130) for pre-training the LLM 208B. After training the LLM 208B, the server 130 can securely transmit the one or more of adjusted parameters to the user device 120 via the network 110.

In some implementations, the system 200 of the user device 120 can finetune the pre-trained LLM 208B by training the LLM 208B using the training dataset generated using the one or more of contextual information associated with a user and a one or more of prior communications of the user. During the finetuning process, the one or more of training parameters of the LLM 208B are adjusted to improve the performance of the LLM 208B on the specific task of generating responses for queries.

In some implementations, finetuning the LLM 208B is a supervised training process using the query-response pairs along with the one or more additional attributes of the training samples. Other techniques of finetuning can also be implemented by the system 200 including for example, reinforcement learning from human feedback or reinforcement learning from machine learning model feedback. For example, the server 130 can implement a superior LLM that can securely monitor the finetuning process of a weaker LLM 208B on the user device 120 and provide feedback as and when necessary.

In some implementations, the user may want the LLM 208B to generate responses for a particular entity in such a way that the responses are similar to the user’s prior responses (e.g., similar to the user’s syntax, vocabulary, and/or choice of words during prior communications). In such implementations, the system 200 can further finetune the LLM 208B by training the LLM 208B on a one or more of secondary training datasets where each of the secondary training dataset is specific to an entity. In such implementations, a secondary dataset that is specific for an entity includes a set of words that were used by the user in prior communications with the entity. Likewise, the system 200 can generate a respective secondary dataset for each of the respective entity and train the LLM 208B on each of the secondary training datasets.

Following the training process, the virtual assistant can use the trained LLM 208B for handling communications such as incoming/outgoing calls and texts on behalf of the user. For example, assume that the user is driving and wants the virtual assistant to handle all communications. The user can activate the LLM 208B using the option 410 as depicted in FIG. 4. When the user device 120 receives a text message from an entity, the virtual assistant provides the text as a query to the LLM 208B. If the entity is a known entity i.e., the user device 120 has a profile for the entity saved in the contacts application, the virtual assistant can also provide the one or more pre-configured data privacy settings to the LLM 208B. The LLM 208B can process the query along with the current data privacy settings to generate a response. The virtual assistant can then transmit the generated response to the entity as a text message.

In some implementations, if the user device 120 receives an incoming call from an entity, the virtual assistant can activate the LLM 208B for generating responses. For example, the processor 202 can retrieve the trained LLM 208B from the storage 212 of the user device 120 and place the LLM 208B in the memory 204. In such implementations, the virtual assistant can use the synthesizer to transcribe speech in the audio stream received from the entity into text. After transcribing, the virtual assistant can provide the text as query to the LLM 208B. If the entity is a known entity, the virtual assistant can also provide the one or more pre-configured data privacy settings to the LLM 208B. The LLM 208B can then process the query along with the pre-configured data privacy settings to generate a response. The virtual assistant can then use the synthesizer to generate an audio file based on the generated response and can transmit the audio file back to the entity as an audio stream.

In some implementations, a synthesizer can convert speech in an audio file (or stream) into text and vice-versa. In some implementations, the synthesizer is a machine learning model that is trained to convert speech in an audio file into text. The synthesizer is also trained to convert text into speech. In some implementations, the synthesizer is further trained to generate audio that resembles the user’s voice and speech characteristics (e.g., pronunciations, voice timbre, etc.) In some implementations, the synthesizer can be trained using a one or more of prior communications such as phone calls so as to learn the user’s voice and speech characteristics.

In some implementations, the LLM 208B can be used to perform tasks specified by the user. For example, the user can provide a voice command to the virtual assistant for calling a particular entity and scheduling a meeting. In such implementations, the virtual assistant can use the synthesizer to convert the speech of the audio from the user into text. The virtual assistant can then activate the LLM 208B and can provide the text as a query to the LLM 208B. The LLM 208B can process the query to identify the entity from the text. In some implementations, after successful identification of the entity, the LLM 208B can request the virtual assistant for the entity’s data privacy settings. In response, the virtual assistant can provide the data privacy settings of the entity as input to the LLM 208B.

The LLM 208B can process the data privacy settings of the entity along with the query to generate a response. Meanwhile, the virtual assistant can initiate a voice call with the identified entity. If the entity accepts the voice call, the virtual assistant can use the synthesizer to convert the response into an audio stream and/or file. Depending on the data privacy settings of the entity, the LLM 208B can instruct the synthesizer to generate audio with specific properties. For example, if the entity is a family member and the user has selected the selectable control option 416 for fidelity, the LLM 208B can instruct the synthesizer to generate an audio file with same voice and speech characteristics as the entity. If the entity is an acquaintance, the LLM 208B can instruct the synthesizer to generate an audio file with a neutral voice and speech characteristics.

In some implementations, the user may need to take over an ongoing communication being handled by the LLM 208B with an entity. For example, assume that the entity is a representative from a banking organization calling to confirm recent monetary transactions. The representative may ask one or more questions to authenticate the user’s identity. For example, assume that the representative asks for the account passcode. In such a situation, the LLM 208B cannot generate a correct response since the LLM 208B was never trained on such sensitive information. In this situation, the LLM 208B can prompt the user to take over the call. For example, the LLM 208B can display a prompt on the display 214 of the user device 120. The user can interact with the prompt to take over the call from the LLM 208B.

As for another example, the user may ask the virtual assistant to call a IVR of a bank and handover the call as soon as the call is transferred to a bank representative. The virtual assistant can initiate a call with the IVR of the bank and starts to interact with the IVR. For example, the virtual assistant can use the LLM 208B to generate responses to queries provided by the IVR. In such a situation, the LLM 208B can generate responses that directs the IVR to transfer the call to a bank representative. When the call is transferred to a bank representative, the virtual assistant can determine that the representative is a human by evaluating the responses using the LLM 208B. In response to identifying that the representative is a human, the LLM 208B can request the virtual assistant to prompt the user to take over the call.

In some implementations, the LLM 208B can provide notifications to the user regarding tasks that were handled by the LLM 208B. For example, if the LLM 208B handled a call from a banking organization offering the user with a credit card, the LLM 208B can generate a notification for the user. Likewise, the LLM 208B can generate a notification for all tasks handles by the LLM 208B. The notifications are then logged and stored in the storage 212 and prompted to the user by displaying the notifications on the display 214 of the user device 120.

In some embodiments, the system 200 of the user device 120 can finetune the LLM 208B by continuously training the LLM 208B based on the user’s feedback. In such embodiments, the LLM 208B can process a query to generate a response, which is then presented to the user. The user can provide a feedback by editing the response to generate a user-specific response which is a more personalized version of the response. The system 200 can subsequently use the original response generated by the LLM 208B and the user-specific response to further finetune the LLM 208B. This is further explained with reference to FIG. 5.

FIG. 5 illustrates a block diagram 500 of continuous training of the LLM 208B. When an application such as the messaging application of the user device 120 receives a text message from an entity, the virtual assistant can provide the text message as a query to the LLM 208B. If the entity is a known entity e.g., the user device 120 has a profile for the entity saved in a contacts application, the virtual assistant can also provide the one or more pre-configured data privacy settings associated to the profile of the entity to the LLM 208B. If the entity is a known entity, the virtual assistant can also provide samples of prior communications with the entity as input to the LLM 208B along with contextual information 502 which may include information collected from the profile of the user, and/or collected from native and/or third-party applications executing on the user device 120. The LLM 208B can then process the query along with the current data privacy settings, samples of prior communication 209 and contextual information (if available) to generate a response 504.

In some embodiments, the generated response 504 is provided to the user for personalization. For example, the virtual assistant can use the display 214 of the system 200 of the user device 120 to present the generated response to the user. The user can edit the response to generate a user-specific response 506 which is a more personalized version of the response. The virtual assistant can then use the user-specific response 506 to respond back to the entity by transmitting the user-specific response 506 using the messaging application. The virtual assistant can further instruct the system 200 to use the user-specific response 506 to further finetune the LLM 208B. In response, the system 200 of the user device 120 can finetune the LLM 208B using a feedback loop 508. For example, the system 200 can use a loss function such as a cross entropy loss function to determine an error associated with generating the response 504. The system 200 can use the error as the feedback loop 508 to train the LLM 208B. As for another example, the system 200 of the user device 120 can create a training sample using the query, the current data privacy settings, samples of prior communication data 209, the contextual information 502, the generated response 504 and the user-specific response 506. The system 200 can then finetune the LLM 208B by adjusting one or more of the training parameters of the LLM 208B on the task of generating a response that is similar to the user-specific response 506. The system 200 can continue with the process of refining the LLM 208B every time the user generates a user-specific response thereby improving the efficiency of the LLM 208B overtime.

In some embodiments, the virtual assistant can use the LLM 208B to enhance brief messages such as snippets provided by the user into more detailed and customized responses suitable for an entity. For example, assume that the user receives a message from an entity on the messaging application on the user device 120. Instead of composing a full response, the user can input a short snippet through the messaging application. By indicating an instruction within the messaging application 207, the user can direct the virtual assistant to use the LLM 208B to process the snippet along with the pre-configured data privacy settings to generate an expanded version of the snippet. The expanded version of the snippet can be presented to the user prior to transmitting the expanded version via the messaging application. In some embodiments, instead of providing a short snippet as input, the user can also dictate the snippet. In such embodiments, the messaging application (or the virtual assistant) can use the synthesizer to transcribe speech in the audio stream of the snippet received from the user into text. By indicating an instruction within the messaging application (or by instructing the virtual assistant using voice command), the user can direct the virtual assistant to use the LLM 208B to process the snippet to generate an expanded version of the snippet that is suitable for the entity.

FIG. 6 illustrates an example use of a large language model-based communication assistant in conjunction with a wearable device (e.g., a smartwatch 604.) As illustrated in FIG. 6, a user may want to send a message to an entity using the smartwatch 604. Given that user input and/or output mechanisms on wearable devices such as smartwatches may be constrained, e.g., due to size limitations, it may not be feasible and/or practical for a user to input a detailed message. In this case, the user can use the UI of the smartwatch 604 to select and/or input a short snippet for the message. For example, the user can select a snippet from a set of snippets 606-612 that can be displayed on the smartwatch 604. In some embodiments, each snippet in the set of snippets is pre-configured. In one or more implementations, if the user is responding to a prior message received from the entity, each snippet in the set of snippets can be dynamically generated by the LLM 208B operating in the smartwatch 604. In such embodiments, each snippet is tailored according to the context of the conversation and is formatted to fit on the display of the smartwatch 604. A virtual assistant (or an operating system) of the smartwatch 604 can process the selected snippet and the pre-configured data privacy settings using the LLM 208B to generate an expanded version of the snippet. The expanded version of the snippet is then transmitted to the entity via the smartwatch 604.

In this manner, a more detailed and/or expanded message can be provided for transmission to the recipient, such as in instances when the user is interacting with an input constrained device, such as a smartwatch, and/or when the user otherwise is not able to, and/or does not, input a detailed and/or complete message.

The techniques and methods described above can also be extended to phone call conversations. Assume that the user is engaged in an activity that prevents the user to attend an incoming call from an entity. In this example, the virtual assistant can use the synthesizer to transcribe speech in the audio stream received from the entity into text. After transcribing, the virtual assistant can provide the text as input to the LLM 208B to generate a set of snippets such that each snippet is tailored according to the context of the conversation and is formatted to fit on the display of the smartwatch 604. The set of snippets 606-612 is then transmitted to and displayed on the smartwatch 604. The user can select a snippet from a set of snippets. The selected snippet can be transmitted back to the user device 120 where the virtual assistant can provide the snippet as input to the LLM 208B to generate an expanded version of the snippet. If the user is responding to a known entity, the virtual assistant can also provide the one or more pre-configured data privacy settings to the LLM 208B. The virtual assistant can then use the synthesizer to generate an audio file based on the expanded version of the selected snippet and can transmit the audio file back to the entity as an audio stream.

In some embodiments, the smartwatch 604 is capable of phone call communications. In such embodiments, the virtual assistant (or the operating system) of the smartwatch 604 can use the synthesizer to transcribe speech in the audio stream received from the entity via a phone call into text. After transcribing, the virtual assistant can use the LLM 208B to generate a set of snippets that are displayed on the smartwatch 604. The user can select a snippet from a set of snippets. The virtual assistant of the smartwatch 604 can use the LLM 208B to generate an expanded version of the snippet. The virtual assistant of the smartwatch 604 can then use the synthesizer to generate an audio file based on the expanded version of the selected snippet and can transmit the audio file back to the entity as an audio stream in the phone call.

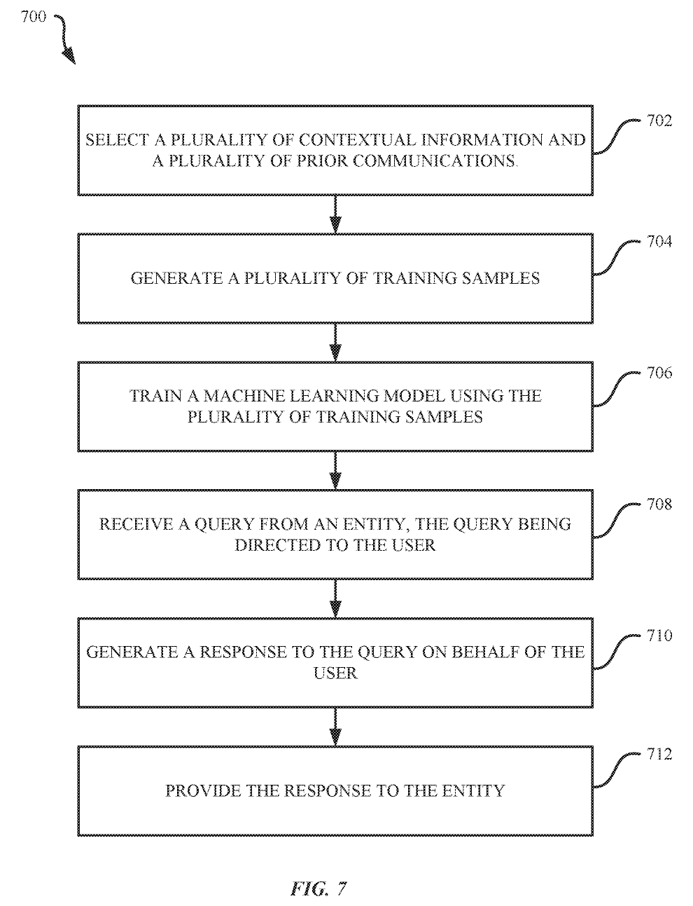

FIG. 7 illustrates a flow diagram of an example process 700 performed by a user device 120 to train a machine learning model according to aspects of the subject technology. For explanatory purposes, the process 700 is primarily described herein with reference to the user device 120 of FIG. 1. However, the process 700 is not limited to the user device 120 of FIG. 1, and one or more blocks (or operations) of the process 700 may be performed by one or more other suitable devices. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, the user device 120 can select a one or more of contextual information and a one or more of prior communications of the user with a one or more of entities based on one or more configurable data privacy settings. With reference to the example provided in FIG. 3, the user can select one or more datatypes 304 such as names, dates, addresses, phone numbers, location, calendar, and financial information. If the user selects a particular datatype 304 using the check boxes 306, the processor 202 can include prior communication that includes information related to the particular datatype in the training dataset.

The processor 202 can select a one or more of contextual information associated with a user for training the LLM 208B. Contextual information associated with the user can include the contextual information from one or more user accounts and one or more native or third-party applications. The processor 202 can retrieve contextual information associated with the user from the storage 212 and select the contextual information for inclusion in the training dataset.

At block 704, the user device 120 generates one or more of training samples. For example, the processor 202 can process the selected prior communications and contextual information to evaluate whether the selected prior communications and contextual information includes any sensitive information, and/or other information that the user does not want to be shared. The processor 202 can process the selected prior communications and contextual information to evaluate whether the selected prior communications and contextual information includes any sensitive information. The selected prior communications and contextual information can be processed using techniques such as rule based model that relies on predefined rules to detect sensitive information or machine learning models that are trained to identify sensitive information.

In response to detecting sensitive information, the portions containing sensitive information can be removed. If the processor 202 determines that a particular prior communication does not include any sensitive information, the processor 202 can include the particular prior communication as a training sample in the training dataset. Besides checking for sensitive information, the processor 202 can also perform sentiment analysis of each of the selected prior communications. If the sentiments determined for any of the selected prior communications belong to a predetermined list of sentiments (e.g., anger, frustration, or resentment), the communication can be skipped from being included in the training dataset. If the processor 202 determines that the sentiment of a particular prior communication is permitted by the user, the particular prior communication can be included as a training sample in the training dataset.

At block 706, the user device 120 trains a machine learning model using the training dataset. For example, the user device 120 can train the LLM 208B using a multi-stage learning process. For example, the user device 120 can train the LLM 208B on vast amounts of unlabeled textual data such as books, articles, and websites. During the training process, the one or more of training parameters of the LLM 208B are adjusted to capture the underlying patterns, structures, and semantic knowledge of the unlabeled textual data. In some implementations, the server 130 may provide a platform to securely train one or more machine learning models for secure deployment to a client electronic device.

The user device 120 can finetune the LLM 208B by training the LLM 208B using the training dataset generated using the one or more of contextual information associated with a user and a one or more of prior communications of the user. Finetuning the LLM 208B is a supervised training process using the query-response pairs along with the one or more additional attributes of the training samples. Other techniques of finetuning can also be implemented by the system 200 including for example, reinforcement learning from human feedback or reinforcement learning from machine learning model feedback.

The user device 120 can further finetune the LLM 208B by training the LLM 208B on a one or more of secondary training datasets where each of the secondary training dataset is specific to an entity. The secondary dataset that is specific for an entity includes a set of words that were used by the user in prior communications with the entity. Likewise, the user device 120 can generate a respective secondary dataset for each of the respective entity and train the LLM 208B on each of the secondary training datasets.

At block 708, the user device 120 receives a query from an entity. For example, the user device 120 receives a call from an entity. The virtual assistant can use the synthesizer to transcribe speech in the audio stream received from the entity into text. The virtual assistant can then provide the text as query to the LLM 208B. If the entity is a known entity, the virtual assistant can also provide the one or more pre-configured data privacy settings to the LLM 208B.

At block 710, the user device 120 generates a response to the query. For example, The LLM 208B can then process the query along with the pre-configured data privacy settings to generate a response.

At block 712, the user device 120 transmits the generated response back to the entity. For example, virtual assistant can use the synthesizer to generate an audio file based on the generated response and can transmit the audio file back to the entity as an audio stream, and/or the virtual assistant can send a text communication that includes the response.

As described above, one aspect of the present technology is the gathering and use of data available from specific and legitimate sources for generating prompts using API requests. The present disclosure contemplates that in some instances, this gathered data may include personal information data that uniquely identifies or can be used to identify a specific person. Such personal information data can include audio data, voice samples, voice profiles, demographic data, location-based data, online identifiers, telephone numbers, email addresses, home addresses, biometric data or records relating to a user’s health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for generating multimedia elements using generative models and detecting one or more attributes related to the multimedia elements.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. In the example of generating prompts using API request, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

Implementations within the scope of the present disclosure include a computer-readable storage medium that encodes instructions organized as an application (e.g. messaging application and phone application) that, when executed by one or more processing units, control an electronic device (e.g., user device 120) to perform the method of FIG. 7 and/or one or more other processes and/or methods described herein.

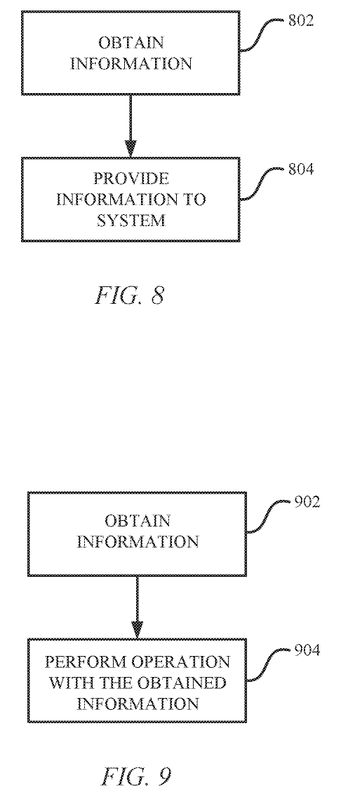

It should be recognized that application 207 (shown in FIG. 8) can be any suitable type of application, including, for example, one or more of: a browser application, an application that functions as an execution environment for plug-ins, widgets or other applications, a fitness application, a health application, a digital payments application, a media application, a social network application, messaging application, phone application, and/or a maps application. In some embodiments, application(s) 207 is an application that is pre-installed on user device 120 at purchase (e.g., a first party application). In other embodiments, application 207 is an application that is provided to user device 120 via an operating system update file (e.g., a first party application or a second party application). In other embodiments, application 207 is an application that is provided via an application store. In some embodiments, the application store can be an application store that is pre-installed on user device 120 at purchase (e.g., a first party application store). In other embodiments, the application store is a third-party application store (e.g., an application store that is provided by another application store, downloaded via a network, and/or read from a storage device).

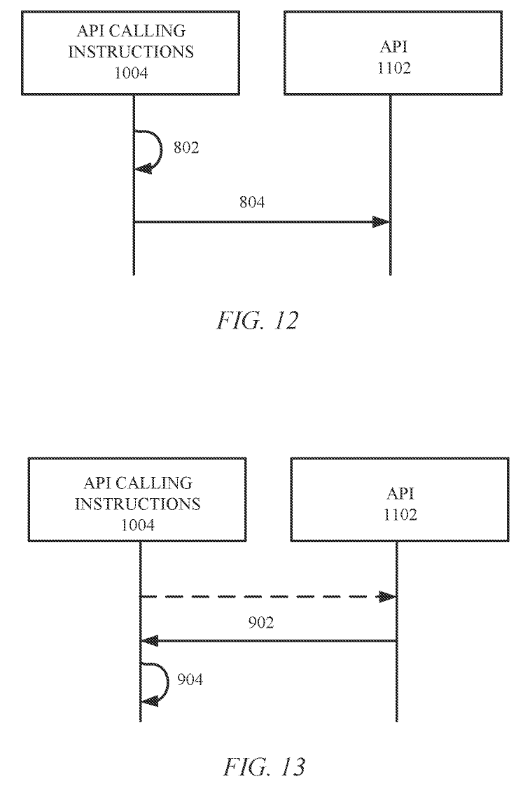

Referring to FIG. 8 and FIG. 12, application 207 obtains information (e.g., at block 02). In some embodiments, at block 802, information is obtained from at least one hardware component of the user device 120. In some embodiments, at block 802, information is obtained from at least one software module (e.g., set of instructions) of the user device 120. In some embodiments, at block 802, information is obtained from at least one hardware component external to the user device 120 (e.g., a peripheral device, an accessory device, a server, etc.). In some embodiments, the information obtained at block 802 includes positional information, time information, notification information, user information, environment information, electronic device state information, weather information, media information, historical information, event information, hardware information, and/or motion information. In some embodiments, in response to and/or after obtaining the information at block 802, application 207 provides the information to a system (e.g., at block 804).

In some embodiments, the system (e.g., block 802 shown in FIG. 8) is an operating system hosted on the user device 120. In some embodiments, the system (e.g., block 802 shown in FIG. 11) is an external device (e.g., a server, a peripheral device, an accessory, a personal computing device, etc.) that includes an operating system.

Referring to FIG. 9 and FIG. 13, application 207 obtains information (e.g., block 902). In some embodiments, the information obtained at block 902 includes positional information, time information, notification information, user information, environment information electronic device state information, weather information, media information, historical information, event information, hardware information and/or motion information. In response to and/or after obtaining the information at block 902, application 207 performs an operation with the information (e.g., block 904). In some embodiments, the operation performed at block 904 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 200 based on the information.

In some embodiments, one or more steps of the method of FIG. 8 and/or the method of FIG. 9 is performed in response to a trigger. In some embodiments, the trigger includes detection of an event, a notification received from system 200, a user input, and/or a response to a call to an API provided by system 200.

In some embodiments, the instructions of application 207, when executed, control user device 120 to perform the method of FIG. 8 and/or the method of FIG. 9 by calling an application programming interface (API) (e.g., API 1102) provided by system 200. In some embodiments, application 207 performs at least a portion of the method of FIG. 8 and/or the method of FIG. 9 without calling API 1102.

In some embodiments, one or more steps of the method of FIG. 8 and/or the method of FIG. 9 includes calling an API (e.g., API 1102) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

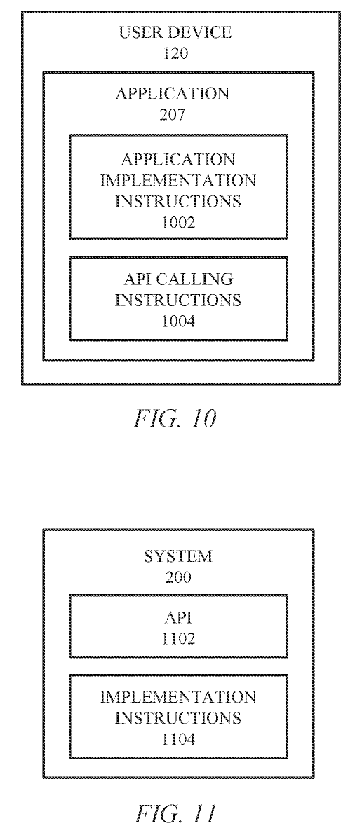

Referring to FIG. 10, user device 120 is illustrated. In some embodiments, user device 120 is a personal computing device, a smart phone, a smart watch, a fitness tracker, a head mounted display (HMD) device, a media device, a communal device, a speaker, a television, and/or a tablet. User device 120 includes application 207 and an operating system (not shown) (e.g., system 200 shown in FIG. 11). Application 207 includes application implementation instructions 1002 and API calling instructions 1004. System 200 includes API 1102 and implementation instructions 1104. It should be recognized that user device 120, application 207, and/or system 200 can include more, fewer, and/or different components than illustrated in FIG. 10 and 11.

In some embodiments, application implementation instructions 1002 is a software module that includes a set of one or more computer-executable instructions. In some embodiments, the set of one or more instructions of instructions 1002 correspond to one or more operations performed by application 207. For example, when application 207 is a messaging application, application implementation instructions 1002 can include operations to receive and send messages. In some embodiments, application implementation instructions 1002 communicates with API calling instructions to communicate with system 200 via API 1102 (shown in FIG. 11).

In some embodiments, API-calling instructions 1004 is a software module that includes a set of one or more computer-executable instructions.

In some embodiments, implementation instructions 1104 is a software module that includes a set of one or more computer-executable instructions.

In some embodiments, API 1102 is a software module that includes a set of one or more computer-executable instructions. In some embodiments, API 1102 provides an interface that allows a different set of instructions (e.g., API calling instructions 1004) to access and/or use one or more functions, methods, procedures, data structures, classes, and/or other services provided by implementation instructions 1104 of system 200. For example, API-calling instructions 1004 can access a feature of implementation instructions 1104 through one or more API calls or invocations (e.g., embodied by a function or a method call) exposed by API 1102 and can pass data and/or control information using one or more parameters via the API calls or invocations. In some embodiments, API 1102 allows application 207 to use a service provided by a Software Development Kit (SDK) library. In other embodiments, application 207 incorporates a call to a function or method provided by the SDK library and provided by API 1102 or uses data types or objects defined in the SDK library and provided by API 1102. In some embodiments, API-calling instructions 1004 makes an API call via API 1102 to access and use a feature of implementation instructions 1104 that is specified by API 1102. In such embodiments, implementation instructions 1104 can return a value via API 1102 to API-calling instructions 1004 in response to the API call. The value can report to application 207 the capabilities or state of a hardware component of user device 120, including those related to aspects such as input capabilities and state, output capabilities and state, processing capability, power state, storage capacity and state, and/or communications capability. In some embodiments, API 1102 is implemented in part by firmware, microcode, or other low level logic that executes in part on the hardware component.

In some embodiments, API 1102 allows a developer of API-calling instructions 1004 (which can be a third-party developer) to leverage a feature provided by implementation instructions 1104. In such embodiments, there can be one or more set of API-calling instructions (e.g., including API-calling instructions 1004) that communicate with implementation instructions 1104. In some embodiments, API 1102 allows multiple sets of API-calling instructions written in different programming languages to communicate with implementation instructions 1104 (e.g., API 1102 can include features for translating calls and returns between implementation instructions 1104 and API-calling instructions 1004) while API 1102 is implemented in terms of a specific programming language. In some embodiments, API-calling instructions 1004 calls APIs from different providers such as a set of APIs from an OS provider, another set of APIs from a plug-in provider, and/or another set of APIs from another provider (e.g., the provider of a software library) or creator of the another set of APIs.

Examples of API 1102 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of user device 120. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 1104 is a system (e.g., operating system, server system) software module (e.g., a collection of computer-readable instructions) that is constructed to perform an operation in response to receiving an API call via API 1102. In some embodiments, implementation instructions 1104 is constructed to provide an API response (via API 1102) as a result of processing an API call. By way of example, implementation instructions 1104 and API-calling instructions 1004 can each be any one of an operating system, a library, a device driver, an API, an application program, or other module. It should be understood that implementation instructions 1104 and API-calling instructions 1004 can be the same or different type of software module from each other. In some embodiments, implementation instructions 1104 is embodied at least in part in firmware, microcode, or other hardware logic.

In some embodiments, implementation instructions 1104 returns a value through API 1102 in response to an API call from API-calling instructions 1004. While API 1102 defines the syntax and result of an API call (e.g., how to invoke the API call and what the API call does), API 1102 might not reveal how implementation instructions 1104 accomplishes the function specified by the API call. Various API calls are transferred via the one or more application programming interfaces between API-calling instructions 1004 and implementation instructions 1104. Transferring the API calls can include issuing, initiating, invoking, calling, receiving, returning, and/or responding to the function calls or messages. In other words, transferring can describe actions by either of API-calling instructions 1004 or implementation instructions 1104. In some embodiments, a function call or other invocation of API 1102 sends and/or receives one or more parameters through a parameter list or other structure.

In some embodiments, implementation instructions 1104 provides more than one API, each providing a different view of or with different aspects of functionality implemented by implementation instructions 1104. For example, one API of implementation instructions 1104 can provide a first set of functions and can be exposed to third party developers, and another API of implementation instructions 1104 can be hidden (e.g., not exposed) and provide a subset of the first set of functions and also provide another set of functions, such as testing or debugging functions which are not in the first set of functions. In some embodiments, implementation instructions 1104 calls one or more other components via an underlying API and thus be both a set of API calling instructions and a set of implementation instructions. It should be recognized that implementation instructions 1104 can include additional functions, methods, classes, data structures, and/or other features that are not specified through API 1102 and are not available to API calling instructions 1004. It should also be recognized that API calling instructions 1004 can be on the same system as implementation instructions 1104 or can be located remotely and access implementation instructions 1104 using API 1102 over a network. In some embodiments, implementation instructions 1104, API 1102, and/or API-calling instructions 1004 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 700 (FIG. 7) is performed at the system 200 implemented in the user device 120 or the server 130 (as described herein) via a system process (e.g., an operating system process, a system process) that is different from one or more applications executing and/or installed on the system 200.

In some embodiments, the process 700 (FIG. 7) is performed at the system 200 (as described herein) by an application that is different from a system process. In some embodiments, the instructions of the application, when executed, control the system 200 to perform the process 700 (FIG. 7) by calling an application programming interface (API) provided by the system process. In some embodiments, the application performs at least a portion of the process 700 (FIG. 7) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the system 200 at purchase (e.g., a first party application). In other embodiments, the application is an application that is provided to the system 200 via an operating system update file (e.g., a first party application). In other embodiments, the application is an application that is provided via an application store. In some implementations, the application store is pre-installed on the system 200 at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the system 200 to perform the process 700 (FIG. 7) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As described above, in some embodiments, the application controls the system 200 to perform the process 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., user device 120) that runs the application. In some embodiments, the set of implementation instructions is included in an electronic device that is separate from the device that runs the application.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

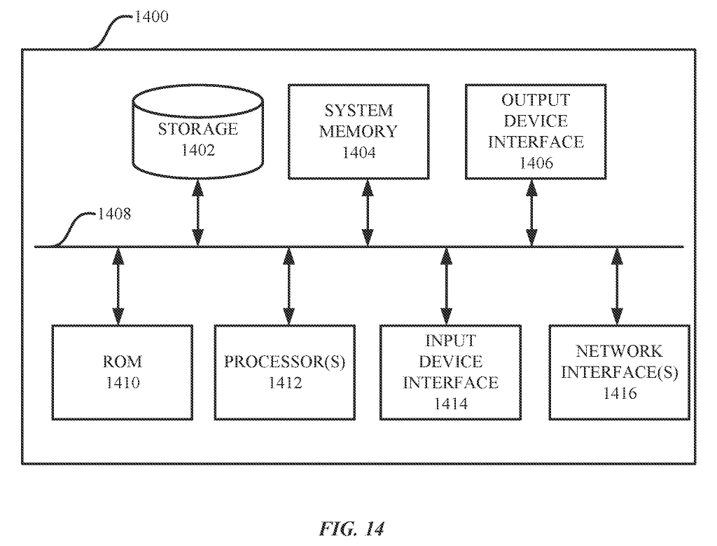

FIG. 14 illustrates an electronic system 1400 with which one or more implementations of the subject technology may be implemented. The electronic system 1400 can be, and/or can be a part of, server 130 and/or user device 120 shown in FIG. 1. The electronic system 1400 may include various types of computer readable media and interfaces for various other types of computer readable media. The electronic system 1400 includes a bus 1408, one or more processing unit(s) 1412, a system memory 1404 (and/or buffer), a ROM 1410, a permanent storage device 1402, an input device interface 1414, an output device interface 1406, and one or more network interfaces 1416, or subsets and variations thereof.

The bus 1408 collectively represents all system, peripheral, and chipset buses that communicatively connect the numerous internal devices of the electronic system 1400. In one or more implementations, the bus 1408 communicatively connects the one or more processing unit(s) 1412 with the ROM 1410, the system memory 1404, and the permanent storage device 1402. From these various memory units, the one or more processing unit(s) 1412 retrieves instructions to execute and data to process in order to execute the processes of the subject disclosure. The one or more processing unit(s) 1412 can be a single processor or a multi-core processor in different implementations.

The ROM 1410 stores static data and instructions that are needed by the one or more processing unit(s) 1412 and other modules of the electronic system 1400. The permanent storage device 1402, on the other hand, may be a read-and-write memory device. The permanent storage device 1402 may be a non-volatile memory unit that stores instructions and data even when the electronic system 1400 is off. In one or more implementations, a mass-storage device (such as a magnetic or optical disk and its corresponding disk drive) may be used as the permanent storage device 1402.

In one or more implementations, a removable storage device (such as a floppy disk, flash drive, and its corresponding disk drive) may be used as the permanent storage device 1402. Like the permanent storage device 1402, the system memory 1404 may be a read-and-write memory device. However, unlike the permanent storage device 1402, the system memory 1404 may be a volatile read-and-write memory, such as random-access memory. The system memory 1404 may store any of the instructions and data that one or more processing unit(s) 1412 may need at runtime. In one or more implementations, the processes of the subject disclosure are stored in the system memory 1404, the permanent storage device 1402, and/or the ROM 1410. From these various memory units, the one or more processing unit(s) 1412 retrieves instructions to execute and data to process in order to execute the processes of one or more implementations.

The bus 1408 also connects to the input and output device interfaces 1414 and 1406. The input device interface 1414 enables a user to communicate information and select commands to the electronic system 1400. Input devices that may be used with the input device interface 1414 may include, for example, alphanumeric keyboards and pointing devices (also called “cursor control devices”). The output device interface 1406 may enable, for example, the display of images generated by electronic system 1400. Output devices that may be used with the output device interface 1406 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 14, the bus 1408 also couples the electronic system 1400 to one or more networks and/or to one or more network nodes, such as the user device 120 shown in FIG. 1, through the one or more network interface(s) 1416. In this manner, the electronic system 1400 can be a part of a network of computers (such as a LAN, a wide area network (“WAN”), or an Intranet, or a network of networks, such as the Internet. Any or all components of the electronic system 1400 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user’s health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to "opt in" or "opt out" of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user’s device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method comprising:
selecting, by a user device, a plurality of contextual information associated with a user and a plurality of prior communications of the user based on one or more pre-configured data privacy settings;
generating a plurality of training samples from the plurality of prior communications and the plurality of contextual information;
training a machine learning model using the plurality of training samples;
receiving a query from an entity, the query being directed to the user;
using the machine learning model to generate a response to the query on behalf of the user; and
providing the response to the entity.

2. The computer-implemented method of claim 1, wherein the plurality of prior communications of the user correspond to a plurality of entities, and the method further comprising:
for each respective entity of the plurality of entities:
generating a respective secondary training dataset that comprises a respective set of words used in a respective subset of the prior communications that are with the respective entity; and
re-training the machine learning model using the respective secondary training dataset; and
using the machine learning model and the one or more pre-configured data privacy settings to generate a response for a query received from one of the plurality of entities.

3. The computer-implemented method of claim 2, wherein the prior communications of the user comprise textual messages communicated by the user to the plurality of entities and textual transcripts of telephonic conversations of the user with the plurality of entities.

4. The computer-implemented method of claim 2, wherein the one or more pre-configured data privacy settings comprise a respective subset of configurable data privacy settings for each respective entity among the plurality of entities.

5. The computer-implemented method of claim 1, wherein the plurality of contextual information comprises contextual information retrieved from one or more user accounts of the user and one or more applications on the user device.

6. The computer-implemented method of claim 5, wherein the one or more applications on the user device comprises a navigation, a calendar, and a contact application.

7. The computer-implemented method of claim 1, wherein the plurality of prior communications and the plurality of contextual information is stored on the user device.

8. The computer-implemented method of claim 1, wherein generating each training sample of the plurality of training samples comprises:
removing one or more portions of the training sample if the one or more portions contain private information of the user; and
performing sentiment analysis on each training sample and excluding a respective training sample from the plurality of training samples if the respective training sample is determined to have one or more pre-specified sentiments.

9. The computer-implemented method of claim 8, wherein the private information of the user comprises one or more user attributes pre-specified by the user.

10. The computer-implemented method of claim 8, wherein the one or more pre-specified sentiments comprises at least one of anger, frustration, or resentment.

11. A device comprising:
a memory; and
a processor configured to:
select a plurality of contextual information associated with a user and a plurality of prior communications of the user based on one or more pre-configured data privacy settings;
generate a plurality of training samples from the plurality of prior communications and the plurality of contextual information;
train a machine learning model using the plurality of training samples;
receive a query from an entity, the query being directed to the user;
use the machine learning model to generate a response to the query on behalf of the user; and
provide the response to the entity.

12. The device of claim 11, wherein the plurality of prior communications of the user correspond to a plurality of entities, and the processor is further configured to:
for each respective entity of the plurality of entities:
generate a respective secondary training dataset that comprises a respective set of words used in a respective subset of the prior communications that are with the respective entity; and
re-train the machine learning model using the respective secondary training dataset; and
use the machine learning model and the one or more pre-configured data privacy settings to generate a response for a query received from one of the plurality of entities.

13. The device of claim 12, wherein the prior communications of the user comprise textual messages communicated by the user to the plurality of entities and textual transcripts of telephonic conversations of the user with the plurality of entities.

14. The device of claim 12, wherein the one or more pre-configured data privacy settings comprise a respective subset of configurable data privacy settings for each respective entity among the plurality of entities.

15. The device of claim 11, wherein the plurality of contextual information comprises contextual information retrieved from one or more user accounts of the user and one or more applications on the device.

16. The device of claim 11, wherein the processor is configured to generate each training sample of the plurality of training samples by:
removing one or more portions of the training sample if the one or more portions contain private information of the user; and
performing sentiment analysis on each training sample and excluding a respective training sample from the plurality of training samples if the respective training sample is determined to have one or more pre-specified sentiments.

17. A computer program product comprising code stored in a tangible computer-readable storage medium, the code comprising:
code to select, by a user device, a plurality of contextual information associated with a user and a plurality of prior communications of the user based on one or more pre-configured data privacy settings;
code to generate a plurality of training samples from the plurality of prior communications and the plurality of contextual information;
code to train a machine learning model using the plurality of training samples;
code to receive a query from an entity, the query being directed to the user;
code to use the machine learning model to generate a response to the query on behalf of the user; and
code to provide the response to the entity.

18. The computer program product of claim 17, wherein the plurality of prior communications of the user correspond to a plurality of entities, and the code further comprising:
for each respective entity of the plurality of entities:
code to generate a respective secondary training dataset that comprises a respective set of words used in a respective subset of the prior communications that are with the respective entity; and
code to re-train the machine learning model using the respective secondary training dataset; and
code to use the machine learning model and the one or more pre-configured data privacy settings to generate a response for a query received from one of the plurality of entities.

19. The computer program product of claim 18, wherein the prior communications of the user comprise textual messages communicated by the user to the plurality of entities and textual transcripts of telephonic conversations of the user with the plurality of entities.

20. The computer program product of claim 18, wherein the one or more pre-configured data privacy settings comprise a respective subset of configurable data privacy settings for each respective entity among the plurality of entities.
